(19) United States
(12) Patent Application Publication
(10) Pub. No.: US 2006/0152875 A1
(43) Pub. Date: Jul. 13, 2006

(54) Overcurrent protection device

(75) Inventors: David Chen, Chung-Ho City (TW); Ben-Mou Yu, Chung-Ho City (TW)

Correspondence Address: BANNER & WITCOFF, 1001 G STREET N W, SUITE 1100, WASHINGTON, DC, 20001, US

(73) Assignee: CABLE VISION ELECTRONICS CO., LTD., Chung-Ho City (TW)

(21) Appl. No.: 11/095,600

(22) Filed: Apr. 1, 2005

(30) Foreign Application Priority Data
Jan. 10, 2005 (TW) 094100619

(51) Int. Cl. H02H 3/08

(52) U.S. Cl. 361/93.1

(57) ABSTRACT

An overcurrent protection device includes a feedback control circuit for outputting a control signal in accordance with a feedback signal that corresponds to an output current signal outputted at an output node of a target circuit, that is received from a feedback output end of the target circuit, and that is to be provided to a control input end of the target circuit so as to cause the feedback signal to reach a preset value. A current limiting circuit, connected to the output node for magnitude control of the output current signal, enables a connection control circuit to connect the feedback control circuit to the control input end when the output current signal is less than a predetermined current value, and enables the connection control circuit to isolate the feedback control circuit from the control input end when the output current signal is not less than the predetermined current value.

### CROSS-REFERENCE TO RELATED APPLICATION

This application claims priority of Taiwanese Application No. 094100619, filed on Jan. 10, 2005.

### BACKGROUND OF THE INVENTION

1. Field of the Invention

The invention relates to a circuit protection device, more particularly to an overcurrent protection device that can effectively provide overcurrent protection to a target circuit.

2. Description of the Related Art

Overcurrent protection circuits are used for controlling a voltage/current output of a target circuit based on a feedback voltage/current signal generated from the target circuit so as to cause the feedback voltage/current signal to reach a preset value, and are widely applied to temperature control, humidity control, motor control, light source control or power control for a DC power supply.

FIG. 1 illustrates a conventional overcurrent protection device 1 for a target circuit 4 that has an npn transistor 42 for outputting an output current signal (Iout) at an emitter thereof, and a load 41 connected to a collector of the transistor 42. The conventional overcurrent protection device 1 includes a feedback control circuit 11 and a current limiting circuit 12. The feedback control circuit 11 is connected to the load 41 via a feedback network 13 for receiving a feedback signal therefrom, and outputs a control signal in accordance with the feedback signal and to be provided to a base of the transistor 42 so as to cause the feedback signal to reach a preset value.

The current limiting circuit 12 includes a detecting unit 121 and a comparator 122. The detecting unit 121 is connected to the emitter of the transistor 42 for detecting the output current signal (Iout) therefrom so as to generate a voltage signal (Vsen) corresponding to the output current signal (Iout). The comparator 122 is an operational amplifier that has a non-inverting input end receiving a reference voltage (Vc1), an inverting input end receiving the voltage signal (Vsen), and an output end connected to a node (M). A diode (D) has a anode electrode connected to the feedback control circuit 11, the base of the transistor 42 and a current source 14, and a cathode electrode connected to the node (M).

When the voltage signal (Vsen) from the detecting unit 121 is less than the reference voltage (Vc1) (i.e., the output current signal (Iout) is less than a predetermined current value that is equal to Vc1/(k×Rsen), where Vc1 is the reference voltage, k is an amplification factor of an operational amplifier 1211 of the detecting unit 121, and Rsen is a resistance value of a resistor connected between non-inverting and inverting input ends of the operational amplifier 1211), the node (M) is at a high level such that the diode (D) is turned off. As such, the feedback control circuit 11 is operated in a normal state, where the control signal can be outputted to the base of the transistor 42. On the other hand, when the voltage signal (Vsen) from the detecting unit 121 is not less than the reference voltage (Vc1) (i.e., the output current signal (Iout) is not less than the predetermined current value), the node (M) is at a low level such that the diode (D) is able to conduct. As such, the feedback control circuit 11 is operated in a saturated state, where the control signal is not provided to the base of the transistor 42. In this case, the current limiting circuit 12 performs magnitude control of the output current signal (Iout).

However, when the output current signal (Iout) is close to the predetermined current value, the potential at the node (M) oscillates between the low and high levels such that the feedback control circuit 11 switches between the normal and saturated states, thereby resulting in unstable magnitude control of the output current signal (Iout).

FIG. 2 illustrates another conventional overcurrent protection device 1′, which is a modification of the overcurrent protection device 1 of FIG. 1. In the overcurrent protection device 1′, the feedback control circuit 11 and the base of the transistor 42 are connected to a node (P). The comparator 122′ of the current limiting circuit 12′ consists of first and second npn transistors (Q1, Q2) where an base of the transistor (Q2) receives the reference voltage (Vc1), emitters of the first and second transistors (Q1, Q2) are connected to each other, a base of the second transistor (Q2) is connected to the detecting unit 121, and a collector of the second transistor (Q2) is connected to a node (N). A pnp transistor 15 has a base connected to the node (N), an emitter connected to the node (P), and a collector. In such a configuration, when the voltage signal (Vsen) from the detecting unit 121 is less than the reference voltage (Vc1), the node (N) is at a high level such that the transistor 15 is turned off. As such, the feedback control circuit 11 is operated in the normal state. On the other hand, when the voltage signal (Vsen) from the detecting unit 121 is not less than the reference voltage (Vc1), the node (N) is at a low level such that the transistor 15 is turned on. As such, the current limit circuit 12′ is able to perform stable magnitude control of the output current signal (Iout).

It is noted that, since the feedback control circuit 11 is connected to the base of the transistor 42, during current limiting control by the current limiting circuit 12, 12′, a ripple response with a large amplitude results in a reduced speed for current limiting control and a large transient output current at the emitter of the transistor 42.

### SUMMARY OF THE INVENTION

Therefore, the object of the present invention is to provide an overcurrent protection device that can overcome the above drawbacks associated with the aforesaid prior art.

According to the present invention, there is provided an overcurrent protection device for a target circuit that has an output node for outputting an output current signal, a feedback output end for outputting a feedback signal corresponding to the output current signal, and a control input end. The overcurrent protection device comprises:

a feedback control circuit adapted to be connected to the feedback output end for receiving the feedback signal therefrom, the feedback control circuit outputting a control signal in accordance with the feedback signal and to be provided to the control input end so as to cause the feedback signal to reach a preset value;

a current limiting circuit adapted to be connected to the output node of the target circuit for magnitude control of the output current signal; and

a connection control circuit connected to the feedback control circuit and the current limiting circuit and adapted to be connected to the control input end.

The current limiting circuit enables said connection control circuit to connect the feedback control circuit to the control input end when the output current signal is less than a predetermined current value, and enables the connection control circuit to isolate the feedback control circuit from the control input end when the output current signal is not less than the predetermined current value.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic electrical circuit diagram of a conventional overcurrent protection device;

FIG. 2 is a schematic electrical circuit diagram of another conventional overcurrent protection device;

FIG. 3 is a schematic electrical circuit diagram illustrating the first preferred embodiment of an overcurrent protection device for a target circuit according to the present invention;

FIG. 4 is an equivalent electrical circuit diagram illustrating the first preferred embodiment when an output current signal outputted from the target circuit is less than a predetermined current value;

FIG. 5 is an equivalent electrical circuit diagram illustrating the first preferred embodiment when the output current signal outputted from the target circuit is not less than a predetermined current value; and

FIG. 6 is a schematic electrical circuit diagram illustrating the second preferred embodiment of an overcurrent protection device for a target circuit according to the present invention.

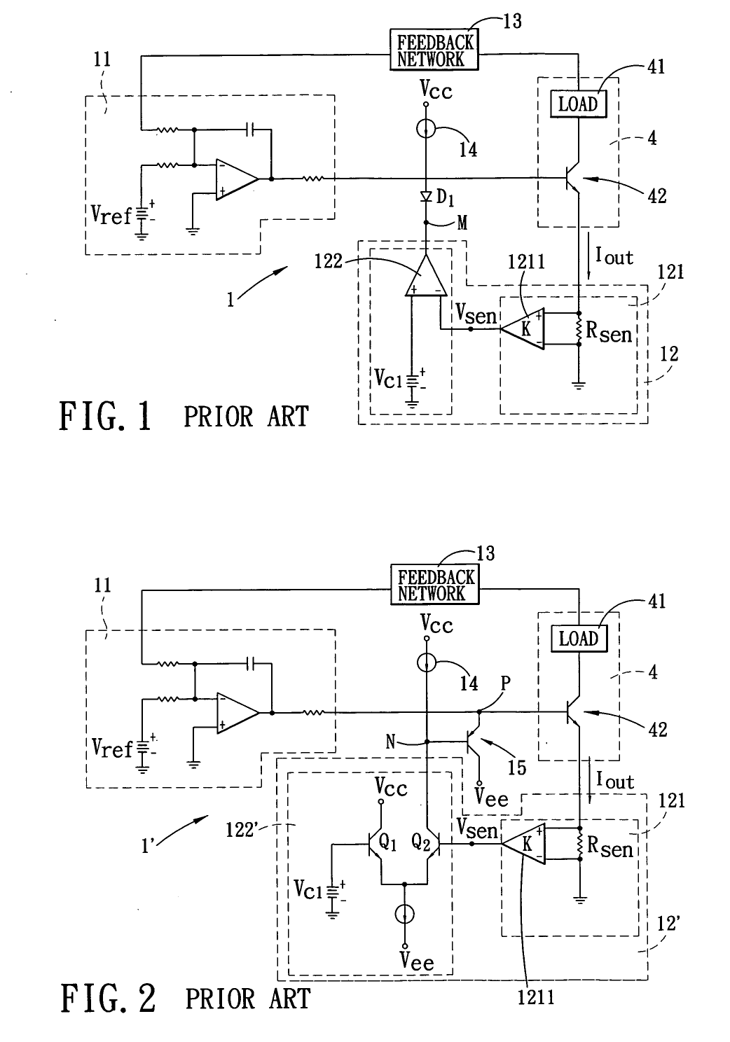

### DETAILED DESCRIPTION OF THE PREFERRED EMBODIMENTS

Before the present invention is described in greater detail, it should be noted that like elements are denoted by the same reference numerals throughout the disclosure.

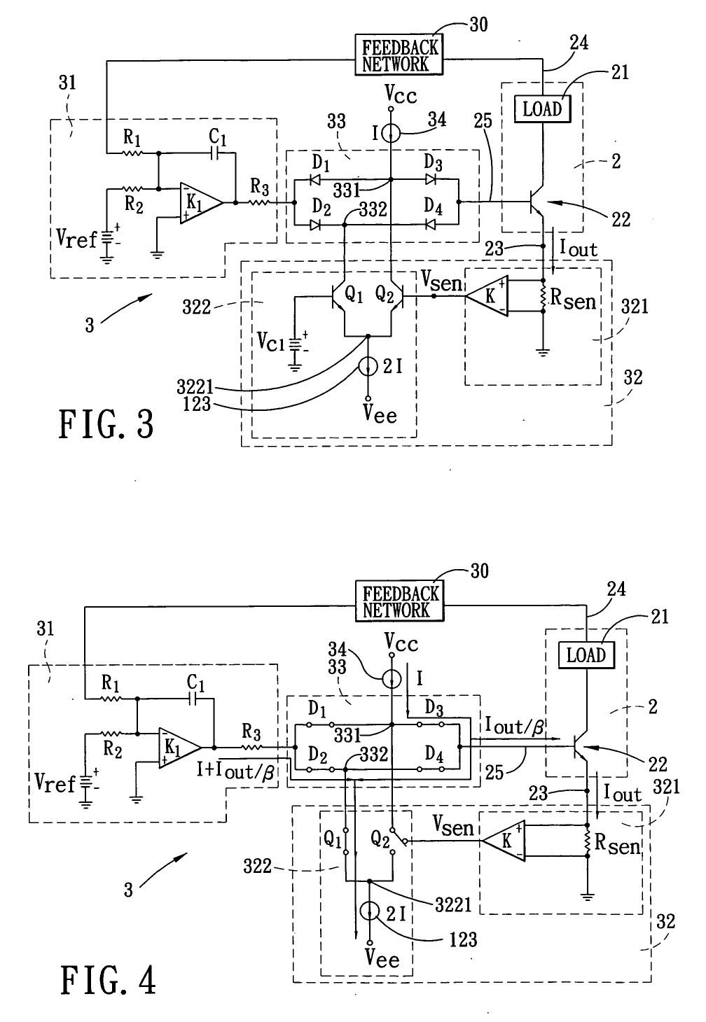

Referring to FIG. 3, according to the first preferred embodiment of this invention, an overcurrent protection device 3 is adapted for a target circuit 2, and is shown to include a feedback control circuit 31, a current limiting circuit 32 and a connection control circuit 33. The target circuit 2 has an output node 23 for outputting an output current signal (Iout), a feedback output end 24 for outputting a feedback signal corresponding to the output current signal (Iout), and a control input end 25. In this embodiment, the target circuit 2 includes a load 21, and an npn transistor 22 that has an emitter serving as the output node 23, a base serving as the control input end 25, and a collector connected to the load 21.

The feedback control circuit 31, which consists of a comparator (K1), resistors (R1, R2, R3), a capacitor (C1) and a voltage source (Vref) in this embodiment, is adapted to be connected to the feedback output end 24 via a feedback network 30 for receiving the feedback signal therefrom. The feedback control circuit 31 outputs a control signal in accordance with the feedback signal and to be provided to the control input end 25 so as to cause the feedback signal to reach a preset value.

The connection control circuit 33 is connected to the feedback control circuit 31, and is adapted to be connected to the control input end 25. In this embodiment, the connection control circuit 33 includes first, second, third and fourth diodes (D1, D2, D3, D4). Anode electrodes of the first and third diodes (D1, D3) are connected to a first node 331. Cathode electrodes of the second and fourth diodes (D2, D4) are connected to a second node 332. A cathode electrode of the first diode (D1) and a anode electrode of the second diode (D2) are connected to the feedback control circuit 31. A cathode electrode of the third diode (D3) and a anode electrode of the fourth diode (D4) are adapted to be connected to the control input end 25 (i.e., the base of the npn transistor 22 of the target circuit 2).

The current limiting circuit 32 is adapted to be connected to the output node 23 of the target circuit 2 for magnitude control of the output current signal (Iout). In this embodiment, the current limiting circuit 32 includes a detecting unit 321 and a comparing unit 322. The detecting unit 321, which consists of a comparator (K) and a resistor (Rsen) in this embodiment, is adapted to be connected to the output node 23 of the target circuit 2 for detecting the output current signal (Iout) therefrom so as to generate a voltage signal (Vsen) corresponding to the output current signal (Iout). The comparing unit 322 is connected to the detecting unit 321, and compares the voltage signal (Vsen) from the detecting unit 321 with a reference voltage (Vc1) associated with a predetermined current value. In this embodiment, the comparing unit 322 includes first and second npn transistors (Q1, Q2). The first npn transistor (Q1) has a first collector connected to the second node 332 of the connection control circuit 33, a first base that receives the reference voltage (Vc1), and a first emitter connected to a third node 3221. The second npn transistor (Q2) has a second collector connected to the first node 331 of the connection control circuit 33, a second base connected to the detecting unit 321 to receive the voltage signal (Vsen) therefrom, and a second emitter connected to the third node 3221.

The overcurrent protection device 3 further includes a first current source 34 that provides a first current flowing into the first node 331, and a second current source 123 that provides a second current flowing out of the third node 3221. In this embodiment, the second current has a magnitude that is twice that of the first current.

It is noted that the current limiting circuit 32 enables the connection control circuit 33 to connect the feedback control circuit 31 to the control input 25 when the output current signal (Iout) is less than a predetermined current value. More specifically, as shown in FIG. 4, when the voltage signal (Vsen) from the detecting unit 321 is less than the reference voltage (Vc1), the second npn transistor (Q2) is turned off and the first npn transistor (Q1) is turned on. Since the magnitude of the second current is twice that of the first current, each of the first, second, third and fourth diodes (D1, D2, D3, D4) must be turned on, thereby forming a closed loop in the connection control circuit 33. In such a configuration, a current of Iout/β, is stably provided at the base of the transistor 22, where β is a current gain of the transistor 22.

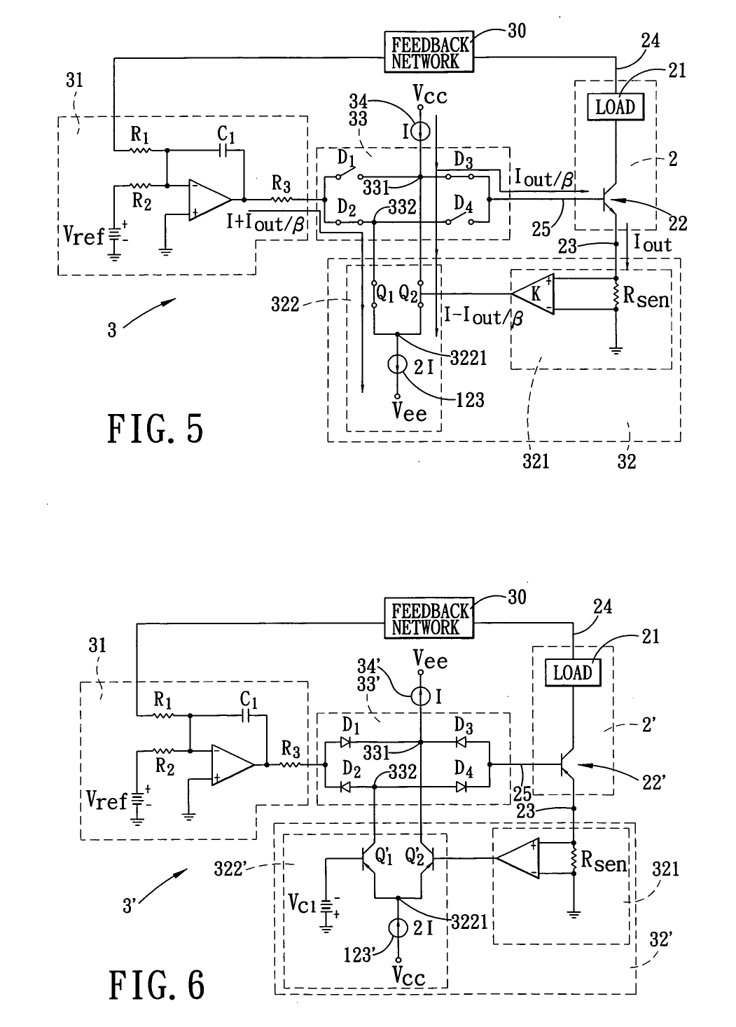

On the other hand, the current limiting circuit 32 enables the connection control circuit 33 to isolate the feedback control circuit 31 from the control input end 25 when the output current signal (Iout) is not less than the predetermined current value. More specifically, as shown in FIG. 5, when the voltage signal (Vsen) from the detecting unit 321 is not less than the reference voltage (Vc1), the first and second npn transistors (Q1, Q2) are turned on. Since a current of I+Iout/β provided from the feedback control circuit 31 flows through the first npn transistor (Q1) and a current of I−Iout/β provided from the first current source 34 flows through the second npn transistor (Q2) the first and fourth diodes (D1, D4) must be turned off and the second and third diodes (D2, D3) must be turned on, thereby isolating the feedback control circuit 31 from the control input end 25. In such a configuration, the feedback control circuit 31 does not affect the target circuit 2, and a stable current is still provided to the base of the transistor 22. Therefore, the output current signal (Iout) can be stably limited to a preset current value.

FIG. 6 illustrates the second preferred embodiment of an overcurrent protection device 3′ according to this invention, which is a modification of the first preferred embodiment.

In this embodiment, the target circuit 2′ includes the load 21, and a pnp transistor 22′ that has an emitter serving as the output node 23, a base serving as the control input end 25, and a collector connected to the load 21. In the connection control circuit 33′, the cathode electrodes of the first and third diodes (D1, D3) are connected to the first node 331, the anode electrodes of the second and fourth diodes (D2, D4) are connected to the second node 332, the anode electrode of the first diode (D1) and the cathode electrode of the second diode (D2) are connected to the feedback control circuit 31, and the anode electrode of the third diode (D3) and the cathode electrode of the fourth diode (D4) are adapted to be connected to the control input end 25.

The comparing unit 322′ of the current limiting circuit 32 includes first and second pnp transistor (Q1′, Q2′). The first pnp transistor (Q1) has a first collector connected to the second node 332, a first base that receives the reference voltage (Vc1), and a first emitter connected to the third node 3221. The second pnp transistor (Q2′) has a second collector connected to the first node 331, a second base connected to the detecting unit 321, and a second emitter connected to the third node 3221.

The first current source 34′ provides the first current that flows out of the first node 331, and the second current source 123′ provides the second current that flows into the third node 3221.

The operation of the second preferred embodiment is analogous to that of the previous embodiment and will not be detailed further for the sake of brevity.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. An overcurrent protection device for a target circuit that has an output node for outputting an output current signal, a feedback output end for outputting a feedback signal corresponding to the output current signal, and a control input end, said overcurrent protection device comprising:
a feedback control circuit adapted to be connected to the feedback output end for receiving the feedback signal therefrom, said feedback control circuit outputting a control signal in accordance with the feedback signal and to be provided to the control input end so as to cause the feedback signal to reach a preset value;
a current limiting circuit adapted to be connected to the output node of the target circuit for magnitude control of the output current signal; and
a connection control circuit connected to said feedback control circuit and said current limiting circuit and adapted to be connected to the control input end;
said current limiting circuit enabling said connection control circuit to connect said feedback control circuit to the control input end when the output current signal is less than a predetermined current value, and enabling said connection control circuit to isolate said feedback control circuit from the control input end when the output current signal is not less than the predetermined current value.

2. The overcurrent protection device as claimed in claim 1, wherein said current limiting circuit includes:
a detecting unit adapted to be connected to the output node of the target circuit for detecting the output current signal therefrom so as to generate a voltage signal corresponding to the output current signal; and
a comparing unit connected to said connection control circuit and said detecting unit, said comparing unit comparing the voltage signal from said detecting unit with a reference voltage associated with the predetermined current value;
said comparing unit enabling said connection control circuit to connect said feedback control circuit to the control input end when the voltage signal from said detecting unit is less than the reference voltage, and enabling said connection control circuit to isolate said feedback control circuit from the control input end when the voltage signal is not less than the reference voltage.

3. The overcurrent protection device as claimed in claim 2, the target circuit including a load, and an npn transistor that has an emitter serving as the output node, a base serving as the control input end, and a collector connected to the load, wherein:
said connection control circuit includes first, second, third and fourth diodes, anode electrodes of said first and third diodes being connected to a first node, cathode electrodes of said second and fourth diodes being connected to a second node, a cathode electrode of said first diode and a anode electrode of said second diode being connected to said feedback control circuit, a cathode electrode of said third diode and a anode electrode of said fourth diode being adapted to be connected to the base of the npn transistor of the target circuit.

4. The overcurrent protection device as claimed in claim 3, wherein said comparing unit includes:
a first npn transistor having a first collector connected to said second node of said connection control circuit, a first base that receives the reference voltage, and a first emitter connected to a third node; and
a second npn transistor having a second collector connected to said first node of said connection control circuit, a second base connected to said detecting unit to receive the voltage signal therefrom, and a second emitter connected to said third node.

5. The overcurrent protection device as claimed in claim 4, further comprising:
a first current source that provides a first current flowing into said first node; and
a second current source that provides a second current flowing out of said third node.

6. The overcurrent protection device as claimed in claim 5, wherein the second current has a magnitude that is twice that of the first current.

7. The overcurrent protection device as claimed in claim 2, the target circuit including a load, and a pnp transistor that has an emitter serving as the output node, a base serving as the control input end, and a collector connected to the load, wherein:
said connection control circuit includes first, second, third and fourth diodes, cathode electrodes of said first and third diodes being connected to a first node, anode electrodes of said second and fourth diodes being connected to a second node, a anode electrode of said first diode and a cathode electrode of said second diode being connected to said feedback control circuit, a anode electrode of said third diode and a cathode electrode of said fourth diode being adapted to be connected to the base of the pnp transistor of the target circuit.

8. The overcurrent protection device as claimed in claim 7, wherein said comparing unit includes:
a first pnp transistor having a first collector connected to said second node of said connection control circuit, a first base that receives the reference voltage, and a first emitter connected to a third node; and
a second pnp transistor having a second collector connected to said first node of said connection control circuit, a second base connected to said detecting unit, and a second emitter connected to said third node.

9. The overcurrent protection device as claimed in claim 8, further comprising:
a first current source that provides a first current flowing out of said first node; and
a second current source that provides a second current flowing into said third node.

10. The overcurrent protection device as claimed in claim 9, wherein the second current has a magnitude that is twice that of the first current.
